(19) United States
(12) Patent Application Publication
(10) Pub. No.: US 2014/0371893 A1
(43) Pub. Date: Dec. 18, 2014

(54) AUDIO SIGNATURE SYSTEM AND METHOD

(71) Applicant: Jerry Harvey, Apopka, FL (US)

(72) Inventor: Jerry Harvey, Apopka, FL (US)

(21) Appl. No.: 14/306,313

(22) Filed: Jun. 17, 2014

Related U.S. Application Data
(60) Provisional application No. 61/836,214, filed on Jun. 18, 2013.

(51) Int. Cl. G06F 17/30

(52) U.S. Cl. CPC G06F 17/3074
USPC 700/94

(57) ABSTRACT

An audio signature system may comprise a database including a representative audio signature selected to characterize an audio response of each of a plurality of audio drivers of a particular design. The system may also include a controller to generate preference data of any of the plurality of audio driver's audio responses based upon the representative audio signature and input from a user.

### CROSS-REFERENCE TO RELATED APPLICATIONS

This application claims the benefit of co-pending U.S. Provisional Application No. 61/836,214, filed 18 Jun. 2013 (Agent Docket No. JH09(P)). This application and the application identified above include identical inventorship and ownership.

### BACKGROUND

The embodiments relate to the field of audio drivers.

Listening devices generate sound through an audio driver as will be appreciated by those of skill in the art. For example, personal audio systems, car audio systems, home audio systems, and/or the like generate sound through audio drivers.

### SUMMARY

According to an embodiment, an audio signature system may comprise a database including a representative audio signature selected to characterize an audio response of each of a plurality of audio drivers of a particular design. The system may also include a controller to generate preference data of any of the plurality of audio driver's audio responses based upon the representative audio signature and input from a user.

The system may further include an amplifier and/or an audio equalizer that uses the preference data to shape any of the plurality of audio driver's audio responses. The controller and the database may each be hardware and/or software.

The generation of the representative audio signature to be included in the database may not controlled by the user. The database may include representative audio signatures of a plurality of different particular designs.

One of the pluralities of audio drivers may generate an audio response controlled by the amplifier and/or the audio equalizer's use of the preference data. The database may be local to the user and/or remote to the user.

The system may also include an adjustable user interface used to enter the user input. The adjustable user interface may include a visual representation of the representative audio signature, the preference data, and/or the audio response.

The database may include a representative audio signature of a grouping of audio drivers of various designs. The database may include a representative audio signature of a grouping of audio drivers of various designs used in spaced relations.

Another aspect is a method that may comprise including a representative audio signature selected to characterize an audio response of each of a plurality of audio drivers of a particular design in a database. The method may also include generating preference data of any of the plurality of audio driver's audio responses based upon the representative audio signature and input from a user.

The method may further include using the preference data to shape any of the plurality of audio driver's audio responses. The method may additionally include not controlling by the user generation of the representative audio signature to be included in the database.

The method may also comprise including representative audio signatures of a plurality of different particular designs in the database. The method may further include generating an audio response of one of the plurality of audio drivers controlled by an amplifier and/or an audio equalizer's use of the preference data via one of the plurality of audio drivers.

The method may additionally include positioning the database as local to the user and/or remote to the user. The method may also include providing an adjustable user interface used to enter the user input.

The method may further comprise including a visual representation of the representative audio signature, the preference data, and/or the audio response with the adjustable user interface. The method may additionally comprise including a representative audio signature of a grouping of audio drivers of various designs in the database. The method may also comprise including a representative audio signature of a grouping of audio drivers of various designs used in spaced relations in the database.

### BRIEF DESCRIPTION OF THE DRAWINGS

FIG. 1 is a schematic block diagram of a system in accordance with the embodiments.

FIG. 2 is a graph of an exemplary representative audio signature of the system of FIG. 1.

FIG. 3 is a graph of exemplary preference data of the system of FIG. 1.

FIG. 4 is a graph of a prior art modification system.

FIG. 5 shows the preference data plotted on one graph with the flat curve of the prior art.

FIG. 6 is a graph of the audio response of an audio driver of FIG. 1 after modification by the preference data.

FIG. 7 shows the representative audio signal plotted on a graph with the audio response of audio driver after modification, both of FIG. 1.

FIG. 8 shows the representative audio signal of FIG. 1, the preference data of FIG. 1, the audio response of audio driver after modification of FIG. 1, plotted on one graph with the flat curve of the prior art.

FIG. 9 is a flowchart illustrating method aspects according to various embodiments.

FIG. 10 is a flowchart illustrating method aspects according to the method of FIG. 9.

FIG. 11 is a flowchart illustrating method aspects according to the method of FIG. 9.

FIG. 12 is a flowchart illustrating method aspects according to the method of FIG. 9.

FIG. 13 is a flowchart illustrating method aspects according to the method of FIG. 10.

FIG. 14 is a flowchart illustrating method aspects according to the method of FIG. 9.

FIG. 15 is a flowchart illustrating method aspects according to the method of FIG. 9.

FIG. 16 is a flowchart illustrating method aspects according to the method of FIG. 15.

FIG. 17 is a flowchart illustrating method aspects according to the method of FIG. 9.

FIG. 18 is a flowchart illustrating method aspects according to the method of FIG. 9.

### DETAILED DESCRIPTION

Embodiments will now be described more fully hereinafter with reference to the accompanying drawings, in which preferred embodiments are shown. Like numbers refer to like elements throughout.

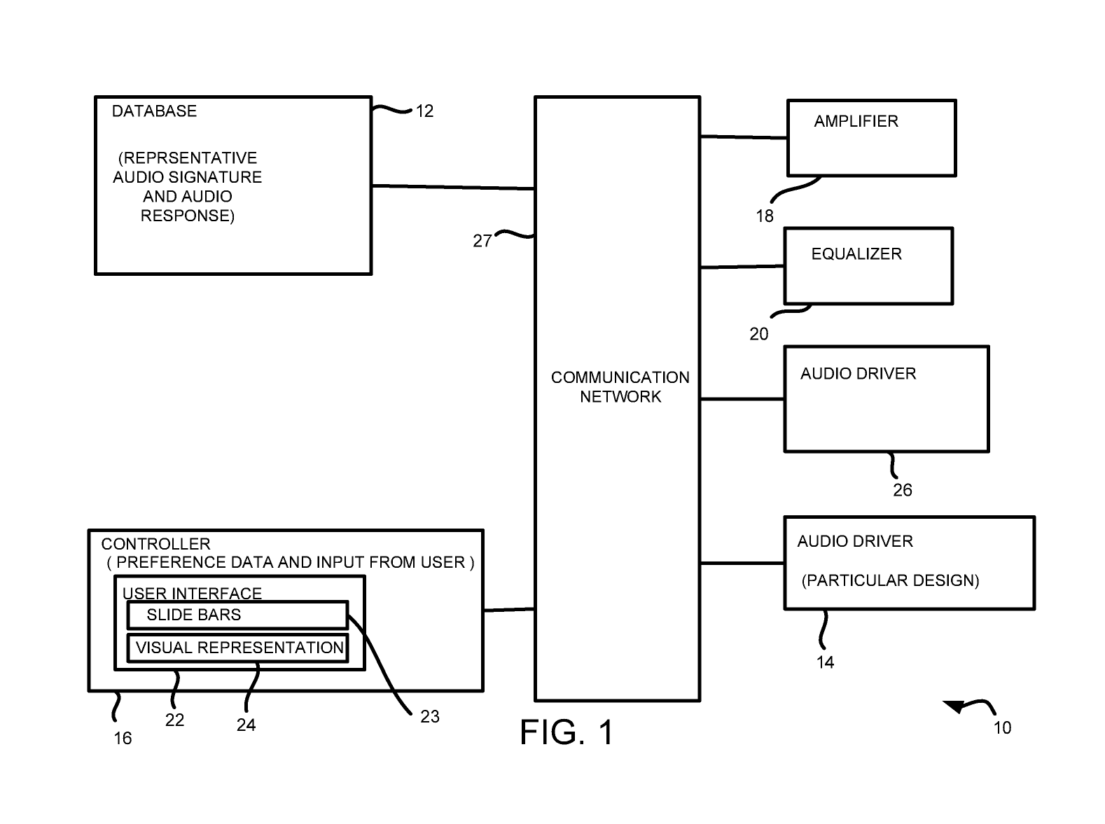

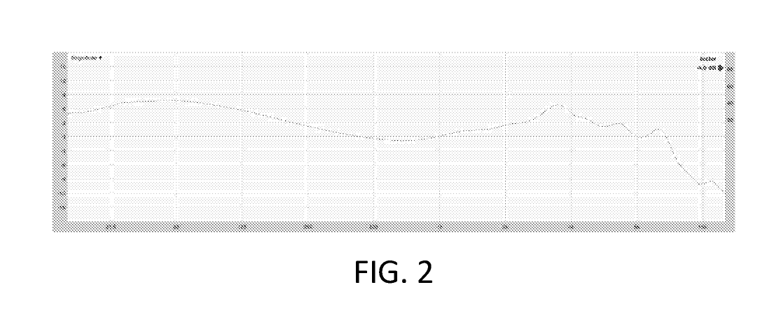

With reference now to FIGS. 1 and 2, an audio signature system 10 is initially described. In one embodiment, the system 10 includes a database 12 including a representative audio signature selected to characterize an audio response of each of a plurality of audio drivers 14 of a particular design. The system 10 also includes a controller 16 to generate preference data of any of the plurality of audio driver's 14 audio responses based upon the representative audio signature and input from a user (not shown).

In one embodiment, the database 12 is a computerized data management system as will be appreciated by those of skill in the art. In another embodiment, the database 12 is made available to the public.

In one embodiment, the representative audio signature is a trace generated by an analyzer, e.g. spectrum analyzer, wave analyzer, and/or the like, of a selected audio driver where the selected audio driver is chosen to represent a class of audio drivers, e.g. Brand X's model T1000 low frequency audio driver. Stated another way, the representative audio signature is made available to the public who purchase/use a selected audio driver 14, e.g. the T1000, but do not have the tools and/or expertise to generate a trace of the selected audio driver.

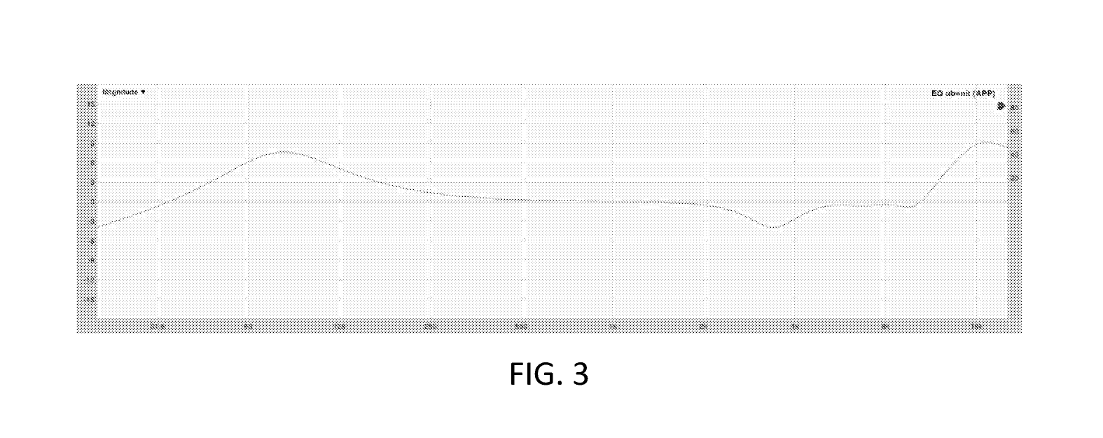

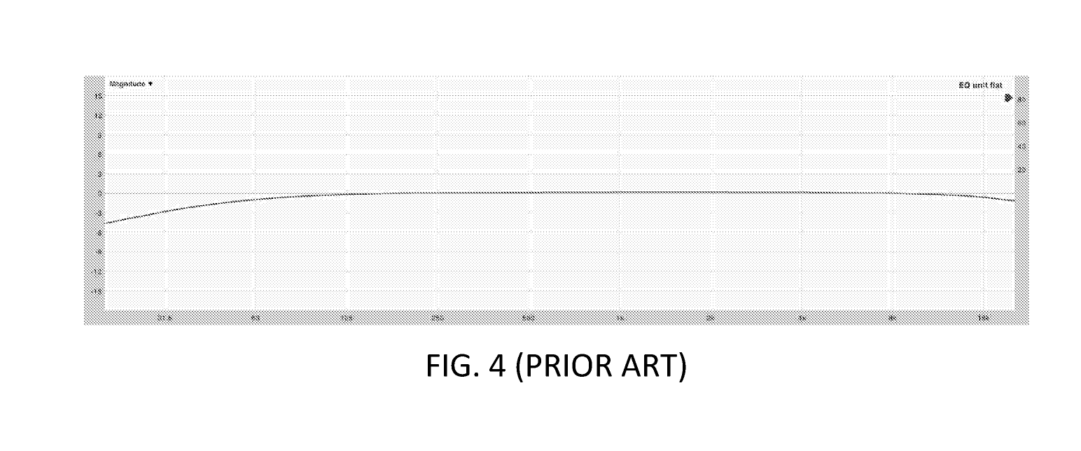

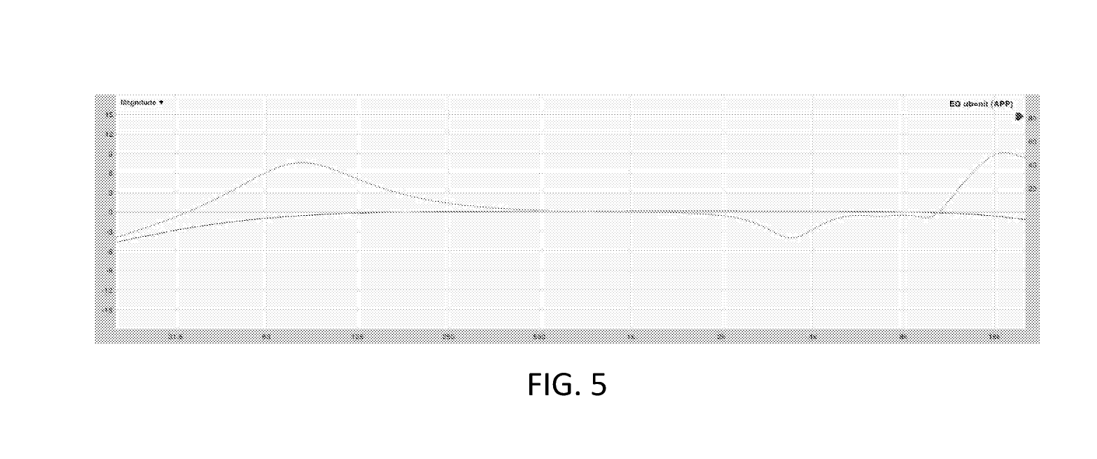

With additional reference to FIG. 3, in another embodiment, the preference data comprises filtering, amplification, and/or the like the user would like to apply to the representative audio signature. In contrast and with reference to FIG. 4, the prior art provides a flat curve that represents a baseline before filters and/or amplification is added to an audio system and there is no correlation between the baseline and an audio signature for any audio driver. FIG. 5 shows the preference data in olive green (FIG. 3) plotted on one graph with the flat curve in black (FIG. 4) of the prior art.

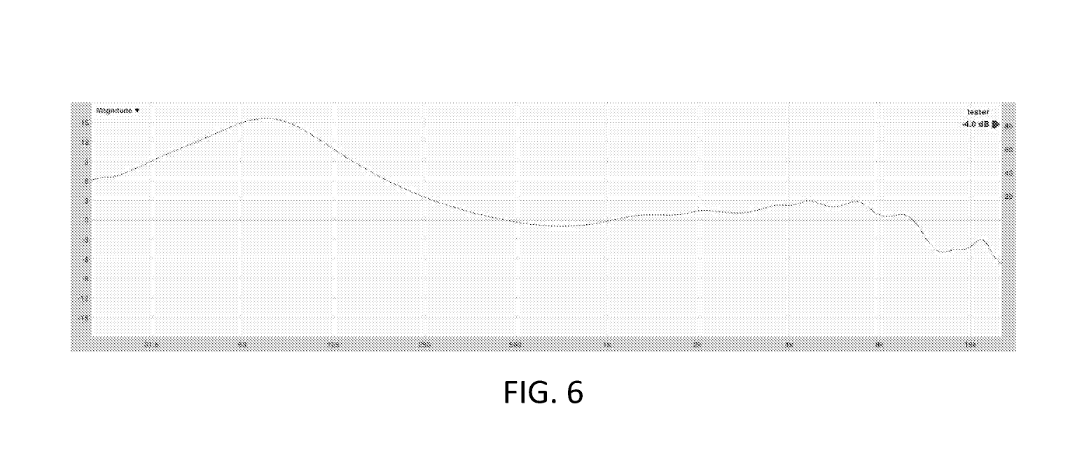

With additional reference to FIG. 6, in one embodiment, the system 10 further includes an amplifier 18, an audio equalizer 20, and/or the like that uses the preference data to shape any of the plurality of audio driver's 14 audio responses. In other words, a user can control the audio response of audio driver 14 better with system 10 than the prior art because the user begins the modification process with a representation, e.g. visual, of the audio response of the audio driver, e.g. representative audio signature, whereas in the prior art, the user had no visual data of the audio response of the audio driver and therefore had to tune the driver solely by ear.

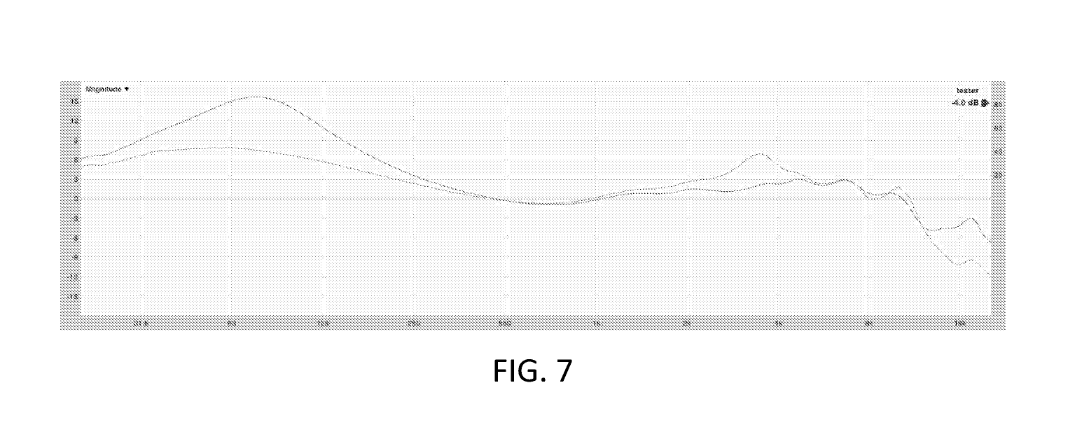

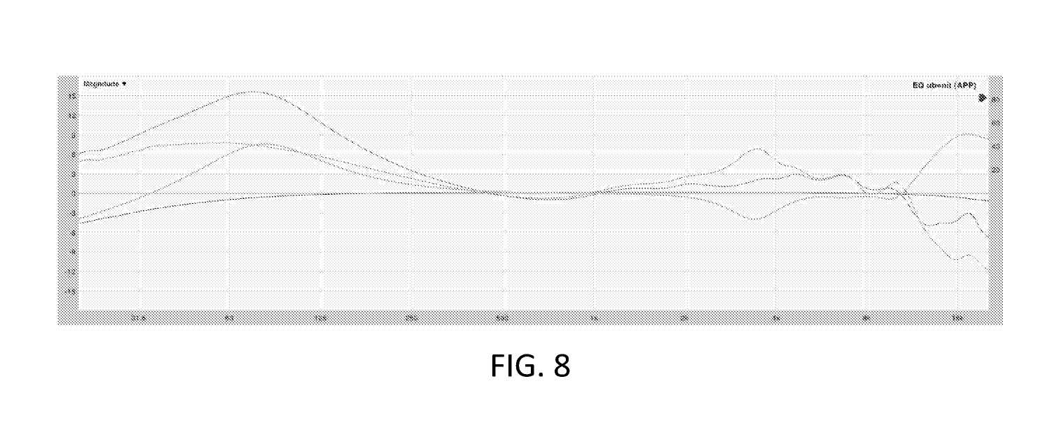

FIG. 7 shows the representative audio signal in beige (FIG. 2) plotted on one graph with the audio response of audio driver 14 in blue after modification (FIG. 6). FIG. 8 shows the representative audio signal in beige (FIG. 2), the preference data in olive green (FIG. 3), the flat curve in black (FIG. 4) of the prior art, plotted on one graph with the audio response of audio driver 14 in blue after modification (FIG. 6).

In one embodiment, the controller 16 and the database 12 are each hardware, firmware, and/or software. In another embodiment, the generation of the representative audio signature to be included in the database 12 is not controlled by the user. For example, the representative audio signature is generated by a third party such as Brand X's manufacturer, a manufacturer that uses Brand X's components, an audio quality company, and/or the like who then makes the representative audio signature available to the user and/or the public.

In one embodiment, the database 12 includes representative audio signatures of a plurality of different particular designs. In other words, the database 12 includes representative audio signatures of different audio drivers such as high frequency audio drivers, mid-frequency audio drivers, low frequency audio drivers, high frequency audio drivers for Brands X, Y and Z, mid-frequency audio drivers for Brands X, Y and Z, low frequency audio drivers for Brands X, Y and Z, and/or the like.

In one embodiment, one of the plurality of audio drivers 14 generates an audio response controlled by the amplifier 18 and/or the audio equalizer's 20 use of the preference data. Stated another way, the user manipulates the audio response of a selected audio driver by controlling the preference data entered into the system 10.

In one embodiment, the database 12 is local to the user and/or remote to the user. For instance, the database 12 is local when the user has physical control over the database, e.g. user holding a personal music player that carries the database. The database 12 is remote to the user when the user does not have physical control over the database, e.g. the user communicates with the database over a communication system such as the Internet, cellular network, and/or the like.

In one embodiment, the system 10 also includes an adjustable user interface 22 used to enter the user input. For example, the adjustable user interface 22 presents slide bars 23 that permit the user to adjust the response of any selected band of the audio response for any of the audio drivers 14.

In one embodiment, the adjustable user interface 22 includes a visual representation 24 of the representative audio signature, the preference data, slide bars 23, the audio response, and/or the like. In another embodiment, the adjustable user interface's 22 visual representation 24 enables the user to see how the representative audio signature is modified by the preference data as well as the audio response of audio drivers 14 and/or 26 based upon the modified representative audio signature.

In one embodiment, the database 12 includes a representative audio signature of a grouping of audio drivers 26 of various designs. For instance, a canalphone, headphone, speaker array, and/or the like comprises high frequency audio drivers, mid-frequency audio drivers, and low frequency audio drivers that are modeled by the representative audio signature for that grouping.

In another embodiment, the database 12 includes a representative audio signature of a grouping of audio drivers 26 of various designs used in spaced relations. For example, a canalphone can use the geometry of the housing and/or sound tubes to influence the audio response of the audio drivers 26 and the system 10 includes a representative audio signature taking this into account. Similarly, headphones, car audio systems, home theater systems, and/or the like use the geometry of the housing, e.g. audio driver placement environment, to influence the audio response of the audio drivers 26, and the system 10 includes a representative audio signature taking this into account.

In one embodiment, the system 10 includes a communications network 27, which enables a signal to travel anywhere within system 10 and/or to any other system connected to system 10. The communications network 27 is wired and/or wireless, for example. The communications network 27 is local and/or global with respect to system 10, for instance, as will be appreciated by those of skill in the art.

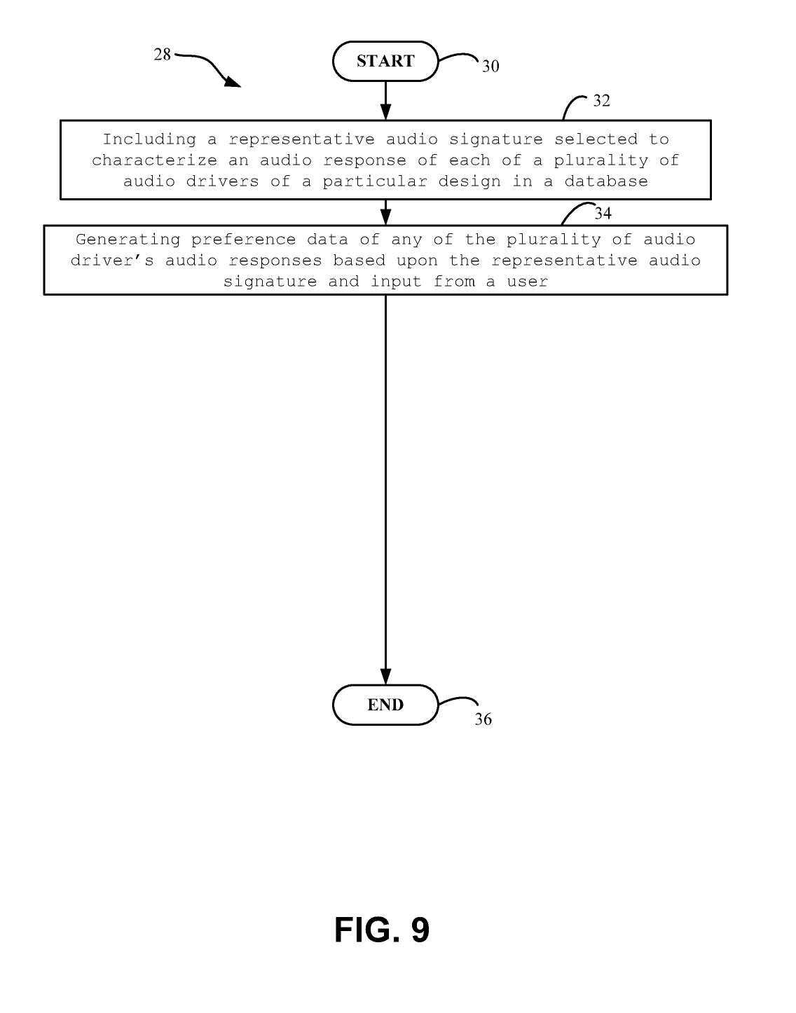

Another aspect is a method, which is now described with reference to flowchart 28 of FIG. 9. The method begins at Block 30 and comprises including a representative audio signature selected to characterize an audio response of each of a plurality of audio drivers of a particular design in a database at Block 32. The method also includes generating preference data of any of the plurality of audio driver's audio responses based upon the representative audio signature and input from a user at Block 34. The method ends at Block 36.

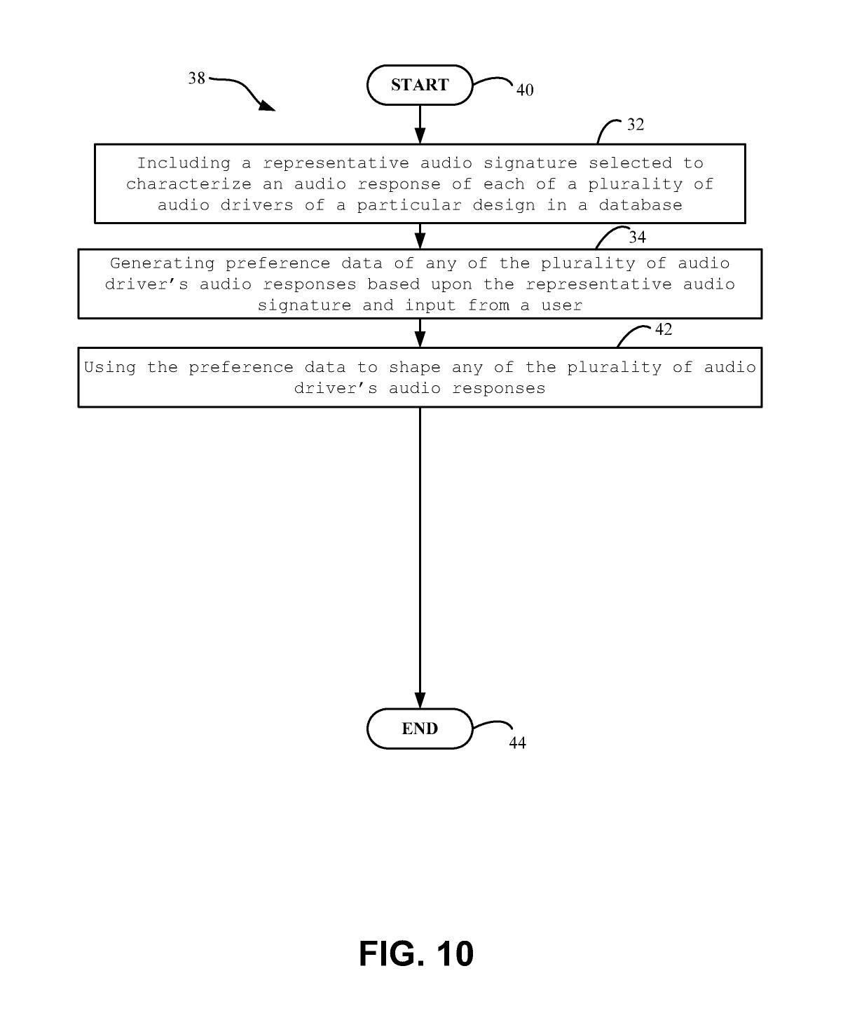

In another method embodiment, which is now described with reference to flowchart 38 of FIG. 10, the method begins at Block 40. The method includes the steps of FIG. 9 at Blocks 32 and 34. The method further includes using the preference data to shape any of the plurality of audio driver's audio responses at Block 42. The method ends at Block 44.

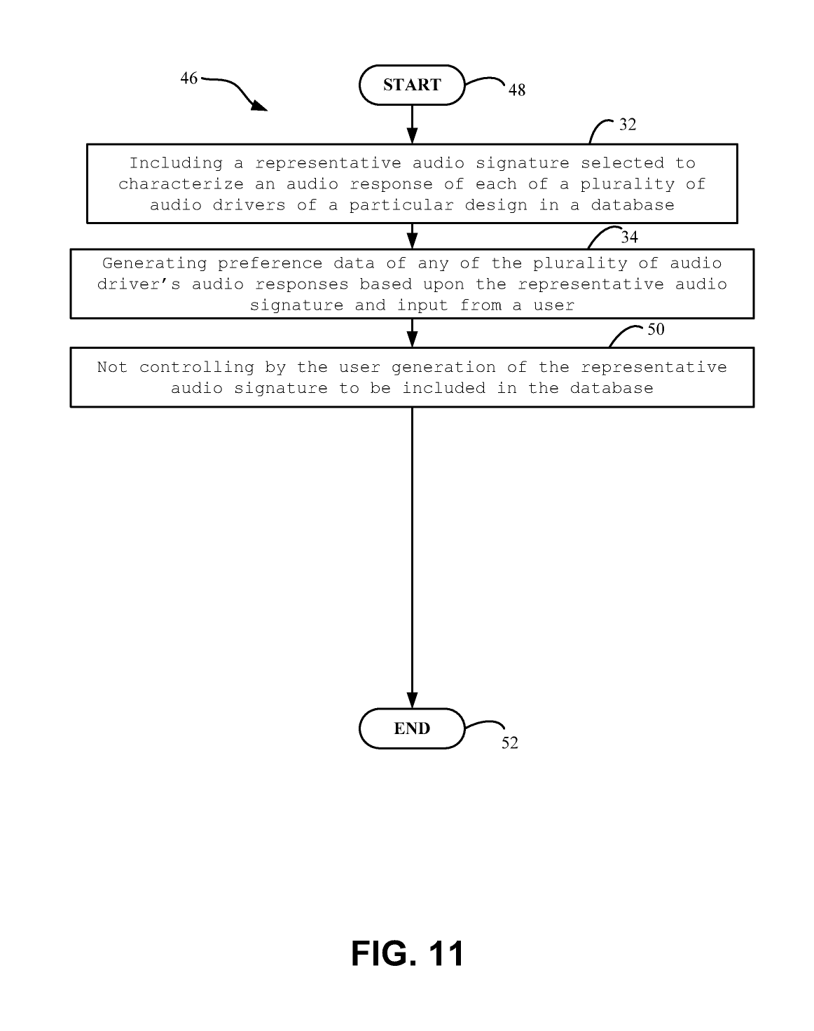

In another method embodiment, which is now described with reference to flowchart 46 of FIG. 11, the method begins at Block 48. The method includes the steps of FIG. 5 at Blocks 32 and 34. The method additionally includes not controlling by the user generation of the representative audio signature to be included in the database at Block 50. The method ends at Block 52.

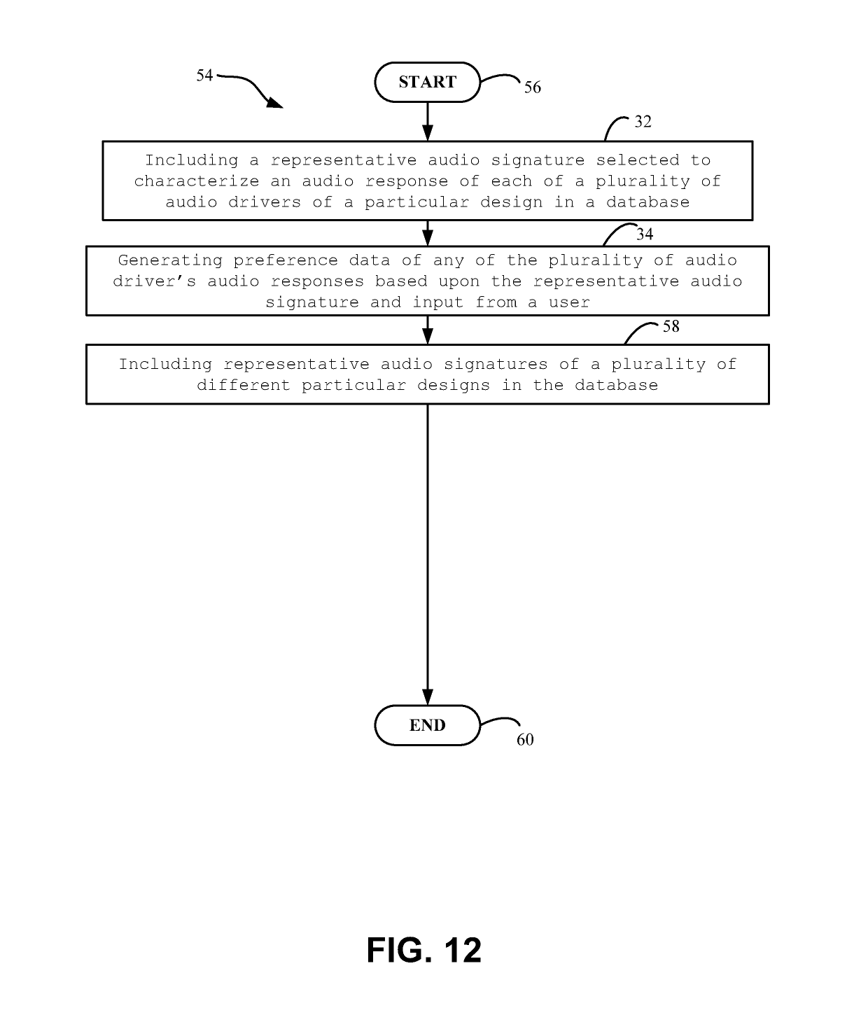

In another method embodiment, which is now described with reference to flowchart 54 of FIG. 12, the method begins at Block 56. The method includes the steps of FIG. 9 at Blocks 32 and 34. The method also comprises including representative audio signatures of a plurality of different particular designs in the database at Block 58. The method ends at Block 60.

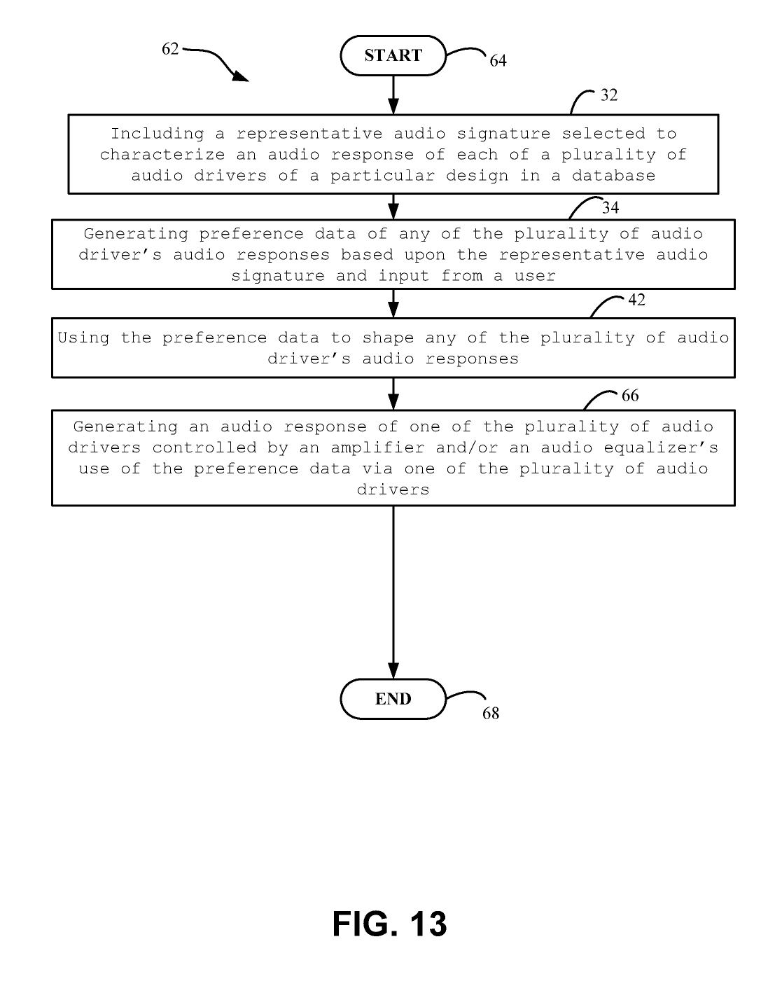

In another method embodiment, which is now described with reference to flowchart 62 of FIG. 13, the method begins at Block 64. The method includes the steps of FIG. 10 at Blocks 32, 34, and 42. The method further includes generating an audio response of one of the plurality of audio drivers controlled by an amplifier and/or an audio equalizer's use of the preference data via one of the plurality of audio drivers at Block 66. The method ends at Block 68.

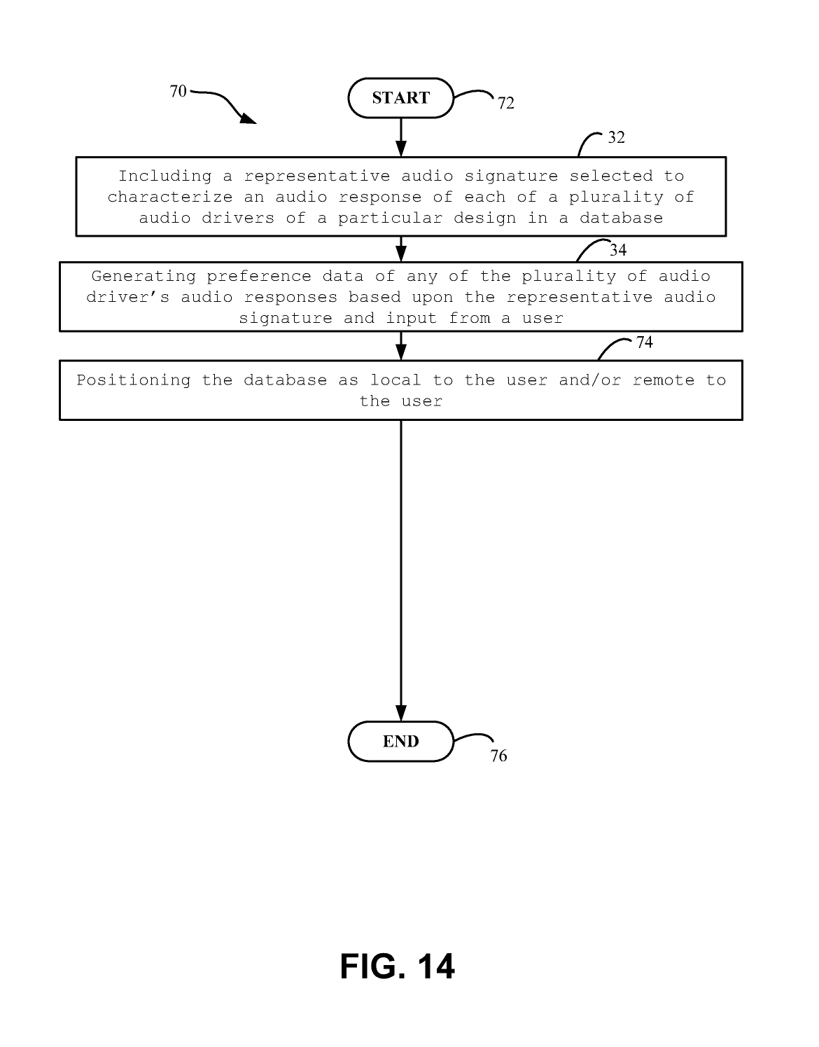

In another method embodiment, which is now described with reference to flowchart 70 of FIG. 14, the method begins at Block 72. The method includes the steps of FIG. 9 at Blocks 32 and 34. The method also additionally includes positioning the database as local to the user and/or remote to the user at Block 74. The method ends at Block 76.

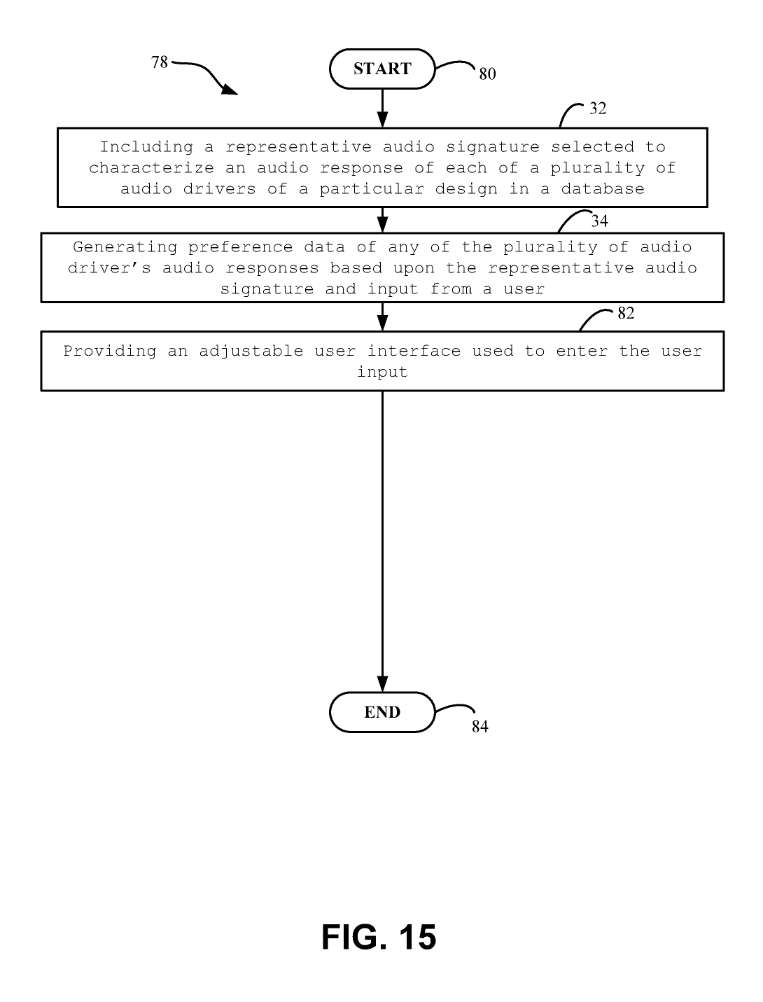

In another method embodiment, which is now described with reference to flowchart 78 of FIG. 15, the method begins at Block 80. The method includes the steps of FIG. 9 at Blocks 32 and 34. The method also includes providing an adjustable user interface used to enter the user input at Block 82. The method ends at Block 84.

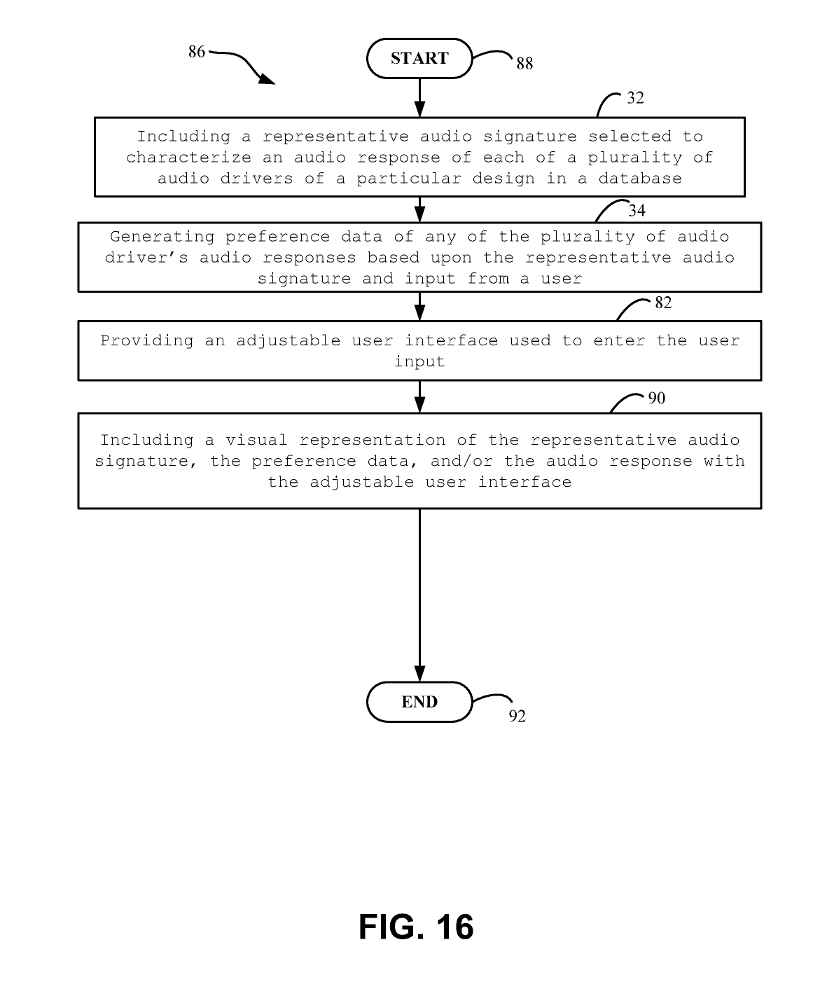

In another method embodiment, which is now described with reference to flowchart 86 of FIG. 16, the method begins at Block 88. The method may include the steps of FIG. 15 at Blocks 32, 34, and 82. The method may also comprise including a visual representation of the representative audio signature, the preference data, and/or the audio response with the adjustable user interface at Block 90. The method ends at Block 92.

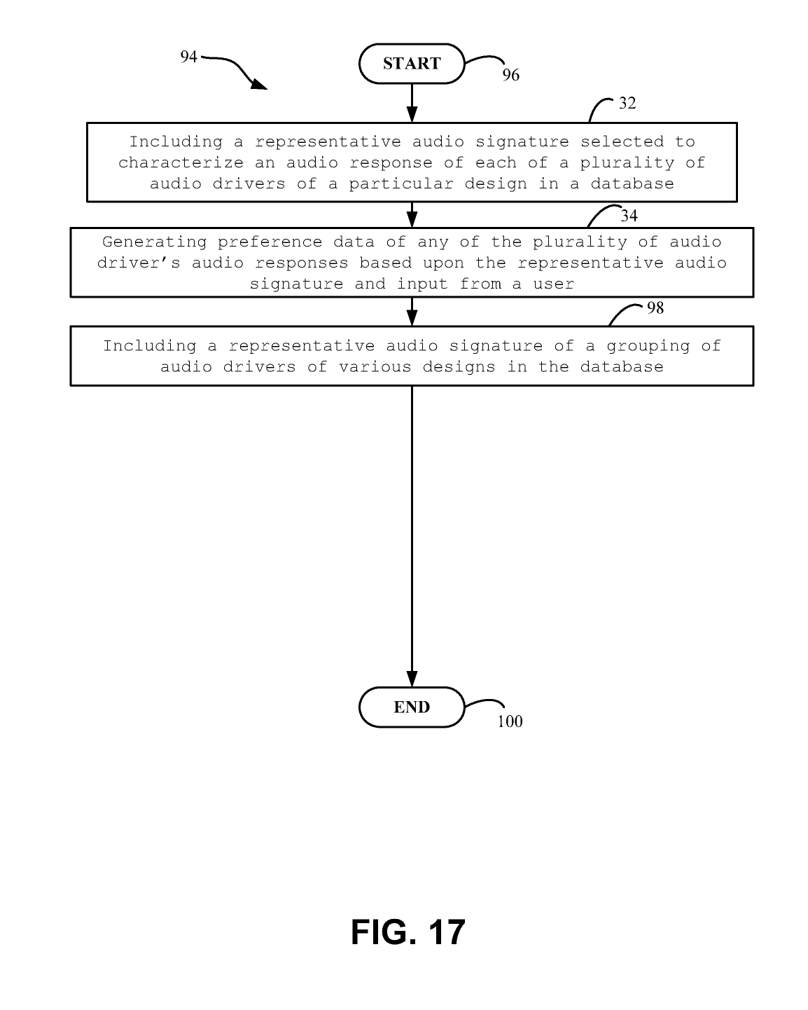

In another method embodiment, which is now described with reference to flowchart 94 of FIG. 17, the method begins at Block 96. The method may include the steps of FIG. 9 at Blocks 32 and 34. The method may also additionally comprise including a representative audio signature of a grouping of audio drivers of various designs in the database at Block 98. The method ends at Block 100.

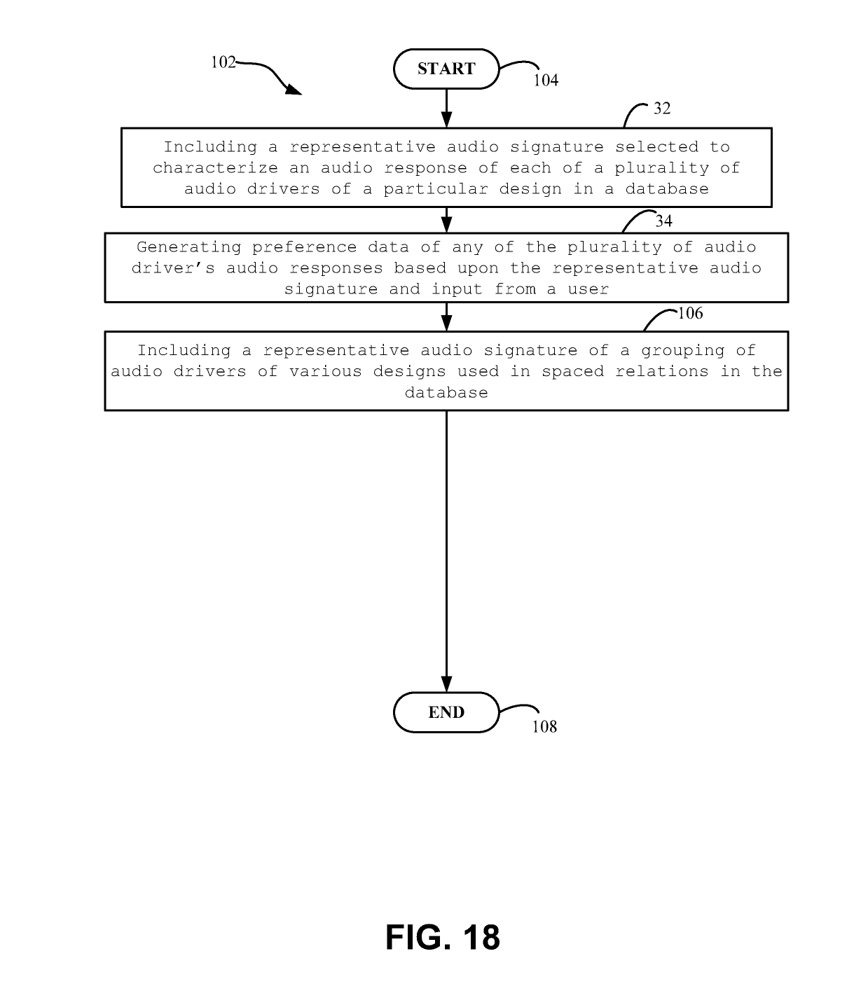

In another method embodiment, which is now described with reference to flowchart 102 of FIG. 18, the method begins at Block 104. The method may include the steps of FIG. 9 at Blocks 32 and 34. The method may also comprise including a representative audio signature of a grouping of audio drivers of various designs used in spaced relations in the database at Block 106. The method ends at Block 108.

Another aspect is of the embodiments is a computer program product embodied in a tangible media comprising computer readable program codes coupled to the tangible media to adjust an audio driver. The computer readable program codes are configured to cause the program to include a representative audio signature selected to characterize an audio response of each of a plurality of audio drivers of a particular design in a database, and generate preference data of any of the plurality of audio driver's audio responses based upon the representative audio signature and input from a user.

In another embodiment, the computer program product further include program code configured to use the preference data to shape any of the plurality of audio driver's audio responses, and/or not control by the user generation of the representative audio signature to be included in the database.

As will be appreciated by one skilled in the art, aspects may be embodied as a system, method, and/or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments are described above with reference to flowchart illustrations and/or block diagrams of methods, apparatus (systems) and computer program products according to the embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated.

While the preferred embodiment has been described, it will be understood that those skilled in the art, both now and in the future, may make various improvements and enhancements which fall within the scope of the claims which follow. These claims should be construed to maintain the proper protection for the embodiments first described.

What is claimed is:

1. A system comprising:
a database including a representative audio signature selected to characterize an audio response of each of a plurality of audio drivers of a particular design; and
a controller to generate preference data of any of the plurality of audio driver's audio responses based upon the representative audio signature and input from a user.

2. The system of claim 1 further comprising at least one of an amplifier and an audio equalizer that uses the preference data to shape any of the plurality of audio driver's audio responses.

3. The system of claim 1 wherein the controller and the database are each at least one of hardware and software.

4. The system of claim 1 wherein generation of the representative audio signature to be included in the database is not controlled by the user.

5. The system of claim 1 wherein the database includes representative audio signatures of a plurality of different particular designs.

6. The system of claim 2 wherein one of the plurality of audio drivers generates an audio response controlled by the at least one of the amplifier and the audio equalizer's use of the preference data.

7. The system of claim 1 wherein the database is at least one of local to the user and remote to the user.

8. The system of claim 1 further comprising an adjustable user interface used to enter the user input.

9. The system of claim 8 wherein the adjustable user interface includes a visual representation of at least one of the representative audio signature, the preference data, and the audio response.

10. The system of claim 1 wherein the database includes a representative audio signature of a grouping of audio drivers of various designs.

11. The system of claim 12 wherein the database includes a representative audio signature of a grouping of audio drivers of various designs used in spaced relations.

12. A method comprising:
including a representative audio signature selected to characterize an audio response of each of a plurality of audio drivers of a particular design in a database; and
generating preference data of any of the plurality of audio driver's audio responses based upon the representative audio signature and input from a user.

13. The method of claim 12 further comprising using the preference data to shape any of the plurality of audio driver's audio responses.

14. The method of claim 12 further comprising not controlling by the user generation of the representative audio signature to be included in the database.

15. The method of claim 12 further comprising including representative audio signatures of a plurality of different particular designs in the database.

16. The method of claim 13 further comprising generating an audio response of one of the plurality of audio drivers controlled by at least one of an amplifier and an audio equalizer's use of the preference data via one of the plurality of audio drivers.

17. The method of claim 18 further comprising including a visual representation of at least one of the representative audio signature, the preference data, and the audio response an adjustable user interface.

18. The method of claim 12 further comprising including a representative audio signature of a grouping of audio drivers of various designs in the database.

19. The method of claim 12 further comprising including a representative audio signature of a grouping of audio drivers of various designs used in spaced relations in the database.

20. A computer program product embodied in a tangible media comprising:
computer readable program codes coupled to the tangible media to adjust an audio driver, the computer readable program codes configured to cause the program to:
include a representative audio signature selected to characterize an audio response of each of a plurality of audio drivers of a particular design in a database; and
generate preference data of any of the plurality of audio driver's audio responses based upon the representative audio signature and input from a user.

21. The computer program product of claim 17 further comprising program code configured to at least one of:
use the preference data to shape any of the plurality of audio driver's audio responses; and
not control by the user generation of the representative audio signature to be included in the database.
